(19) United States
(12) Patent Application Publication
(10) Pub. No.: US 2006/0274362 A1
(43) Pub. Date: Dec. 7, 2006

(54) Image forming system and image forming apparatus

(75) Inventor: Koji Kita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/410,331

(22) Filed: Apr. 24, 2006

(30) Foreign Application Priority Data
Jun. 6, 2005 (JP) JP2005-165141

(51) Int. Cl. G06F 3/12

(52) U.S. Cl. 358/1.15

(57) ABSTRACT

To provide an image forming system and image forming apparatus with improved operability, allowing control, for example, such as operation and status monitoring among image forming apparatuses. In an image forming system in which a plurality of image forming apparatuses are communicably connected via a network, the image forming apparatus includes a display section for displaying an operation screen based on the first display information pertaining to image forming in the own apparatus and a control section for controlling the display section so that the display section displays the second display information pertaining to image forming in another image forming apparatus communicably connected via the network together with the operation screen of the own apparatus.

This application is based on Japanese Patent Application No. 2005-165141 filed on Jun. 6, 2005, in Japanese Patent Office, the entire content of which is hereby incorporated by reference.

### TECHNICAL FIELD

The present invention relates to an image forming apparatus such as a copying machine, printer, facsimile or a multifunctional machine having these functions, as well as an image forming system in which a plurality of image forming apparatuses is communicably connected via a network.

### BACKGROUND

Recently, there has been variously proposed an image forming system in which an image forming apparatus such as a copying machine for forming and outputting an image onto a recording medium such as paper and a remote operation apparatus for remotely operating, such as a PC (Personal Computer), are connected via a network to send an operation instruction from the remote operation apparatus to allow the image forming apparatus to be operated and to allow an operation screen of the image forming apparatus to be displayed on an operation screen of the remote operation apparatus.

For example, there is disclosed a display system of image forming process having: an image forming apparatus body; an operation section provided in the image forming apparatus body, having a display section and operation keys; a workstation in which the image forming process operation of the image forming apparatus body can be remotely controlled; and a display control section for displaying a first display of the same form as the display in the display section and a second display imitating the operation keys, on a screen of the workstation as a display pertaining to remote control (see Patent Document 1).

[Patent Document 1] Japanese Laid-Open Patent Publication No. HEI 6-326797

However, the conventional image forming system as described above has a problem that a user can not confirm the operation and condition of another image forming apparatus when working in the image forming apparatus side. Further, when the same document of text or image and the like is simultaneously sorted and output from a plurality of apparatuses using a tandem function, the user must monitor the plurality of apparatuses tandem outputting the document at the same time. Although summarized information of the operation status of the child machines is displayed on an operation screen of the parent machine, the user can not monitor detailed condition such as the reaming paper and toner. Thereby, the user must move to the image forming apparatus or remote operation apparatus the user desires to monitor when monitoring the operation and condition thereof, so that there is a problem that the conventional system is cumbersome and not user-friendly.

### SUMMARY

In view of forgoing, one embodiment of an image forming apparatus according to one aspect of the present invention is an image forming apparatus, comprising:

a display section which displays first display information about image forming of the image forming apparatus;

a display control section which controls the display section to display second display information of another image forming apparatus connected to and capable of communicating with the image forming apparatus.

According to another aspect of the image forming apparatus, the display control section controls the display section to display the first display information together with the second display information.

According to another aspect of the image forming apparatus, the display control section controls the display section to display and scroll an operation screen which is produced based on the first display information and the second display information.

According to another aspect of the image forming apparatus, the display control section controls the display section to display the operation screens which are produced based on the first display information and the second display information in an overlapping display.

According to another aspect of the image forming apparatus, the operation screen produced based on the second display information includes substantially the same information as an operation screen displayed on the another image forming apparatus.

According to another aspect of the image forming apparatus, the display information includes at least one of functional information and operation status information of the image forming apparatus.

According to another aspect of the image forming apparatus, the image forming apparatus comprising:

a selection input section for selecting an operation screen out of the operation screens which are produced based on the display information displayed on the display section and are displayed on the display section,

wherein the display control section controls the display section to display the operation screen selected by the selection input section larger than the other operation screen.

According to another aspect of the image forming apparatus, the selection input section comprising:

a plurality of function items which are the same as function items on the selected operation screen and able to be selected;

a selection assignment control section which sends a function item assignment information indicated by the function item selected by the selection input section to an image forming apparatus corresponding to the selected operation screen.

According to another aspect of the image forming apparatus, the image forming apparatus comprising:

an own apparatus operation status judgment section which judges whether the image forming apparatus is capable of executing an image forming operation or not,

wherein the image forming apparatus is configured to be capable of selecting an operation screen corresponding to another image forming apparatus, selecting a plurality of function items included in the operation screen and sending the function item assignment information to another image forming apparatus corresponding to the selected operation screen even when the own apparatus operation status judgment section determines the image forming operation not to be operable.

According to another aspect of the image forming apparatus, when the own apparatus operation status judgment section determines the image forming operation not to be operable, the image forming apparatus having the own apparatus operation status judgment section is prohibited from executing the image forming operation.

According to another aspect of the image forming apparatus, the selection assignment control section of the image forming apparatus sends an operation status request signal asking for operation status information of the image forming apparatus corresponding to the selected operation screen to the image forming apparatus corresponding to the selected operation screen and makes a judgment of an operation status of the image forming apparatus corresponding to the operation screen selected based on the operation status information received from the image information apparatus corresponding to the selected operation screen.

According to another aspect of the image forming apparatus, the selection assignment control section of the image forming apparatus prohibits the sending of the function item assignment information in case that the image forming apparatus determines a result of the judgment of the operation status of the image forming apparatus corresponding to the selected operation screen to be inoperative.

According to another aspect of the image forming apparatus, the judgment of the operation status is a judgment whether the image forming operation to be operable or not and/or a communication operation with each other to be operable or not.

According to another aspect of the image forming apparatus, in case of receiving the second display information from the another image forming apparatus, the display control section controls the display section to display the second display information.

### BRIEF DESCRIPTION OF THE DRAWINGS

FIG. 1 is a configuration view of an image forming system 1 in an embodiment;

FIG. 2 is an internal configuration view of an image forming apparatus 21;

FIG. 3 is a flowchart of a display operation of operation screen in the embodiment;

FIG. 4 is an example of a display screen G1 displayed in a display section 260 of the image forming apparatus 21;

FIG. 5 is a flow of a switching operation of operation screen that is executed when a user makes an operation instruction to the display screen G1 shown in FIG. 4;

FIG. 6 is another example of a display screen G2 displayed in the display section 260 of the image forming apparatus 21; and

FIG. 7 is a flowchart of a selection instruction operation that is executed when the user operates and instructs on the display screen of the image forming apparatus 21.

### DETAILED DESCRIPTION OF THE PREFERRED EMBODIMENT

In the embodiment, the description will be made on an example of an image forming system that a plurality of image forming apparatuses each including a WWW (World Wide Web) server (hereinafter referred to as a web server) and a platform on which, for example, browsing software such as a WWW (World Wide Web) browser (hereinafter referred to as a browser) runs, are connected via a network, in which one image forming apparatus displays a webpage, using the browser, as an operation screen that another image forming apparatus provides by the web server to allow the operation of the latter image forming apparatus from the former image forming apparatus.

Hereinafter, the embodiment of the present invention will be described in detail with reference to the accompanying drawings.

First, the configuration will be described.

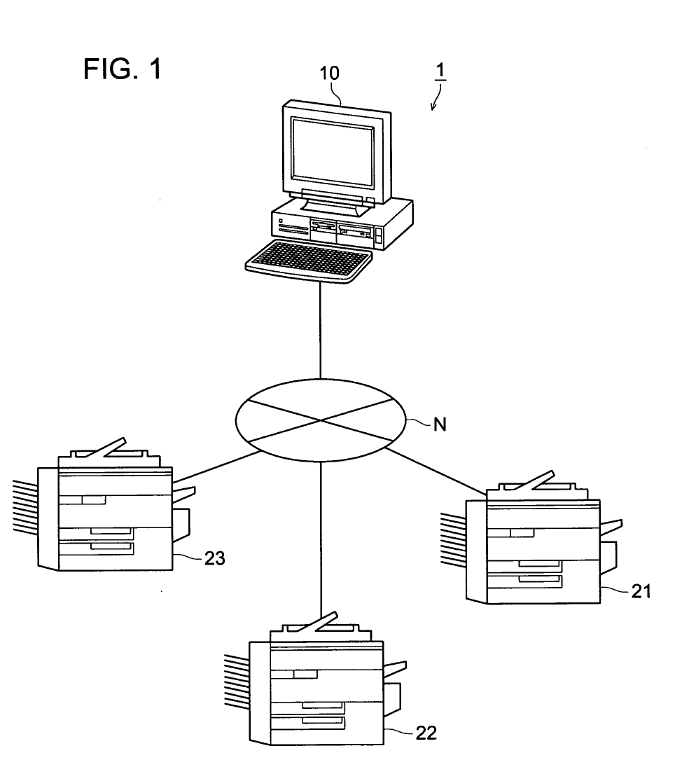

FIG. 1 shows the configuration of an image forming system 1 in the embodiment.

As shown in FIG. 1, the image forming system 1 includes a remote operation apparatus 10 and image forming apparatuses 21, 22, 23 that are connected so as to be able to send and receive information with each other via a network N. Incidentally, FIG. 1 shows the example in which the one remote operation apparatus 10 and three image forming apparatuses are connected, but the number of apparatuses to be provided is not specifically limited.

The remote operation apparatus 10 is an apparatus that is intended to overall remotely monitor and operate the image forming apparatuses 21, 22, 23, for example, browsing operation screens of the image forming apparatuses 21, 22, 23 using the browser, and sending operation instructions executed on the operation screens to the image forming apparatuses 21, 22, 23. For example, an information processing apparatuses such as a general-purpose PC is applicable.

Incidentally, in the embodiment, there is provided with the remote operation apparatus 10 for controlling over the plurality of image forming apparatuses, but the remote operation apparatus 10 may be not provided herein.

The image forming apparatus 21 is an apparatus in which software for providing contents to be browsed by the browser and for browsing the operation screen using the browser is installed, having both the image forming function and the function as a browser and web server, to carry out the process in accordance with the operation instruction from an operation section provided in the apparatus body, or in accordance with the operation instruction sent from the remote operation apparatus 10 or image forming apparatuses 22, 23 via the network. As the image forming apparatus 21, for example, a copying machine, printer, facsimile, or a multifunctional machine having these functions is applicable. The image forming apparatuses 22, 23 are the same as the image forming apparatus 21, and the description is omitted.

The network N may be a LAN (Local Area Network) or a WAN (Wide Area Network), which may include a phone-line network, ISDN (Integrated Services Digital Network) network, wide area communication network, private line, mobile communication network, satellite communication network, CATV (Community Antenna Television) network, optical communication network, wireless communication network and other communication networks, as well as internet service providers connecting these networks.

Next, the image forming apparatus 21 will be described.

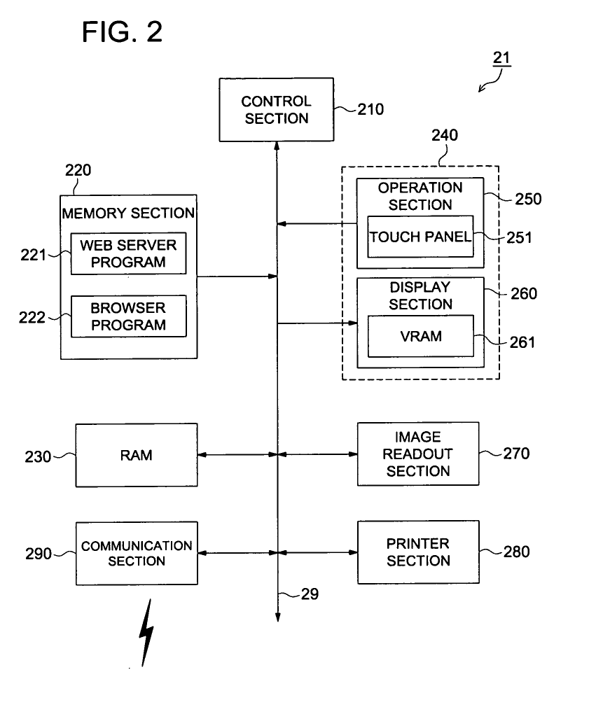

FIG. 2 shows the internal configuration of the image forming apparatus 21.

As shown in FIG. 2, the image forming apparatus 21 includes a controller 210, a memory section 220, a RAM 230, an operation display section 240, an image readout section 270, a printer section 280, and a communication section 290. The sections are communicably connected to each other via a bus 300.

The controller 210 includes a CPU and other components, and expands the system program, various control programs and various data that are stored in the memory section 220, in the RAM 230 to provide control over the sections making up the image forming apparatus 21 in cooperation with the programs and data.

The controller 210 realizes the function of a display control section, in cooperation with the memory section 220 and the RAM 230, for controlling to expand a web server program 221 stored in the memory section 220 in the RAM 230, execute the web server, and send information on the web server to the remote operation apparatus 10 or image forming apparatus that is connected to the network N via the communication section 290, as well as to receive screen data as second display information including the functional information and operation status information the image forming apparatuses 22, 23 have via the communication section 290 from the image forming apparatuses 22, 23, using a browser program 222 and various data stored in the memory section 220, and create operation screens of the image forming apparatuses 22, 23 based on the screen data (display information) to allow the created operation screens to be displayed on a display section 260, together with an operation screen created based on first display information pertaining to image forming in the own apparatus.

The web server functions to carry out image conversion process that converts the operation screen displayed on the display section 260, for example, to screen data of the PNG (Portable Network Graphics) format, accumulate the operation screens displayed by the browser of the remote operation apparatus 10 or image forming apparatuses 22, 23 using the markup language such as HTML (Hyper Text Markup Language) or TEX and the like, and to send these screen data via the network N in response to the request of the browser of the remote operation apparatus 10 or image forming apparatuses 22, 23 and the like.

The operation screen of the other image forming apparatus displayed on the display section 260 of the own apparatus is the image of the same format as the operation screen displayed on the display section of the other image forming apparatus. Operation screens of the own apparatus and other image forming apparatuses are created by the screen data written in a VRAM (Video Random Access Memory) the display section 260 has and by the basic screen data previously stored in the memory section 220.

Further, the controller 210, in cooperation with the memory section 220 and the RAM 230, sends an operation status request signal for requesting operation status information indicating the operation status of a selected image forming apparatus, when sending function item assignment information that the function item selected by the operation section 250 indicates, of a plurality of function items that the operation screen selected by the operation section 250 has, to the image forming apparatus that is selected as described above (hereinafter referred to as the selected image forming apparatus). The controller 210 determines the operation status in the selected image forming apparatus based on the operation status information received from the selected image forming apparatus. As a result of the determination, when determining the selected image forming apparatus is inoperable, the controller 210 prohibits the transmission of the function item assignment information, and when determining it is operable, realizes the function as a selection assignment control section for sending the function item assignment information to the selected image forming apparatus.

The controller 210, in cooperation with the memory section 220 and the RAM 230, realizes the function as a own apparatus operation status judgment section for determining whether the image forming operation is executable in the own apparatus, and when determining that the own apparatus can not execute image forming operation, the controller 210 prohibits execution of the image forming operation in the own apparatus, while selecting the operation screen corresponding to the other image forming apparatus, selecting a plurality of function items the selected screen has, and sending the function item assignment information to the other image forming apparatus corresponding to the selected operation screen.

The determination of the operation status includes, for example, the determination whether the image forming operation is executable and/or whether the mutual communication operation is possible. When the image forming operation is not executable and/or the mutual communication operation is impossible, the transmission of the function item assignment information is prohibited, so that there is no need to carry out transmission control of unnecessary signals, and the control load on the network can be reduced.

Further, the controller 210, when receiving an operation status request signal from the other image forming apparatus, sends operation status information of the own apparatus to the image forming apparatus having sent the operation status request signal. When receiving the function item assignment information from the other image forming apparatus, the controller 210 realizes the function as an operation execution control section for causing the operation based on the function item assignment information to be executed.

The memory section 220 includes a non-volatile memory medium such as a ROM (Read Only Memory) or an HDD (Hard Disk Drive), and stores in this memory medium the system program, various control programs, a web server program 221 for executing the web server, a browser program 222 for executing the browser, a program required for the image conversion process, and data relating to these programs, all of which are executed by the controller 210.

The RAM 230 forms a work area for temporarily storing the various programs and data relating to these programs executed by the controller 210.

The operation display section 240 includes an operation section 250 as a selection input section for allowing different function items to be selected, and a display section 260 as a display section for displaying the operation screen indicating the different function items and operation status.

The operation section 250 has a touch panel 251 and various operation hard keys (not shown).

The touch panel 251 is overlapped on the display screen displayed on an LCD of the display section 260, detecting coordinates corresponding to each position of the function items shown in the operation screen on the display screen, receiving the selection instruction of the operation screen of the own apparatus or other image forming apparatus that is displayed on the display screen by outputting the detected coordinates to the controller 210, and further realizing the function as a selection input section for receiving the selection instructions of the function items of the selected operation screen. The detection of coordinates can be carried out by electromagnetic induction, magnetostriction, pressure-sensitive or other methods.

The various operation hard keys are a selection input section for selecting functions different from the function items of the operation screen displayed on the display screen, including hard keys such as a copy start key and a numeric keypad, which outputs the operation signals of these hard keys to the controller 210.

The display section 260 includes a display screen such as the LCD (Liquid Crystal Display) and a VRAM 261 for temporarily storing data for causing the operation screen showing the items of the functions that the own apparatus or the other image forming apparatus has to be displayed on the display screen, and carries out a required display process in accordance with the data written to the VRAM 261 from the controller 210.

The image readout section 270 includes photoelectric transducer elements such as a light source and CCD (Charge Coupled Devices) that are provided in the lower part of a contact glass. The image readout section 270 optically scans an original document placed on the contact glass, photoelectrically converts its reflection light by the CCD, and digitally converts the photoelectrically converted light to obtain screen data of the original document. The screen data of the original document is stored in a printer section 280 as print data.

The printer section 280 includes a paper feeder (not shown) for feeding various recording materials, and forms an image on a specified recording medium based on the print data that is instructed to be printed from the external device such as the remote operation apparatus 10, or the other image forming apparatus 22 or 23. Incidentally, any print method such as an electrophotographic method or an inkjet method may be used herein.

The communication section 290 includes various interfaces such as NIC, modem, and USB, to mutually send and receive information with the external devices on the network N.

Incidentally, the internal configurations of the image forming apparatuses 22, 23 are the same as that of the image forming apparatus 21, so that the illustration and description are omitted.

Next, the operation of the embodiment will be described.

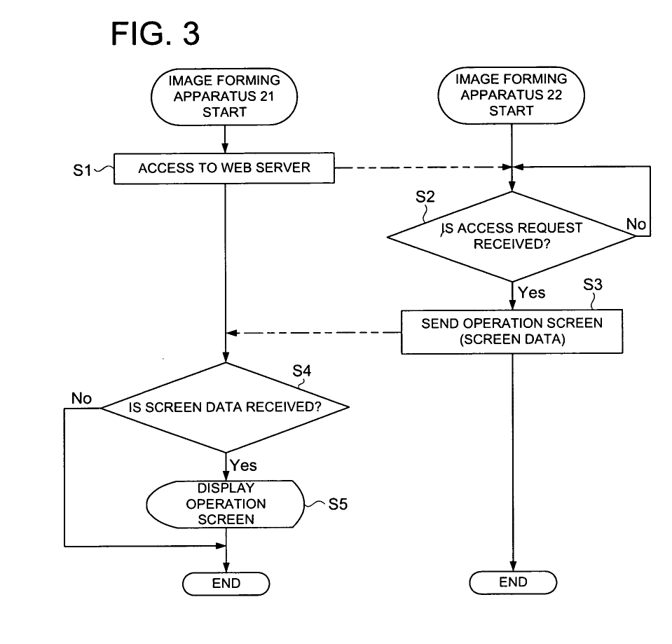

FIG. 3 shows the flowchart of the operation screen display operation in the embodiment.

The flowchart of the operation screen display operation shown in FIG. 3 illustrates the flow in the case of allowing the operation screen of the image forming apparatus 22 to be displayed on the display screen of the image forming apparatus 21. Incidentally, it is assumed that the flowchart of the operation screen display process shown in FIG. 3 is repeatedly executed periodically at a predetermined interval, during a period of time in which the power is supplied to the image forming apparatuses 21, 22.

The controller 210 of the image forming apparatus 21 accesses the web server of the image forming apparatus 22 that is connected to the network (Step S1).

The web server executed in the controller of the image forming apparatus 22 determines whether it has received an access request from the image forming apparatus 21 (Step S2), and when determining it has not received the access request (Step S2: No), waits until receiving the access request.

The web server executed in the controller of the image forming apparatus 22, when determining it has received the access request (Step S2: Yes), reads out the screen data that is stored in the VARM and displayed on the display screen of the display section as the display information of the operation screen of the own apparatus, and sends the read-out screen data of the own apparatus to the image forming apparatus 21 (Step S3).

The controller 210 of the image forming apparatus 21 determines whether it has received the screen data from the image forming apparatus 22 (Step S4), and when determining it has received the screen data (Step S4: Yes), creates an operation screen of the image forming apparatus 22 in accordance with the screen data received using the browser to allow the created operation screen to be displayed on the display screen of the display section 260, together with the operation screen of the own apparatus (Step S5).

The controller 210 of the image forming apparatus 21, when determining it does not receive the screen data after a predetermined period of time has elapsed (Step S4: No), or after Step S5, ends the operation of operation screen display.

Incidentally, in light of the amount of communication traffic, the screen data sent from the image forming apparatus 22 may be screen data for displaying a previously reduced operation screen of file size (thumbnail). Preferably, when the double-sides selection instruction is made for the thumbnail displayed on the display screen of the display section 260, the operation of obtaining again the screen data is executed from Step S1 so that the operation screen of its original size is displayed.

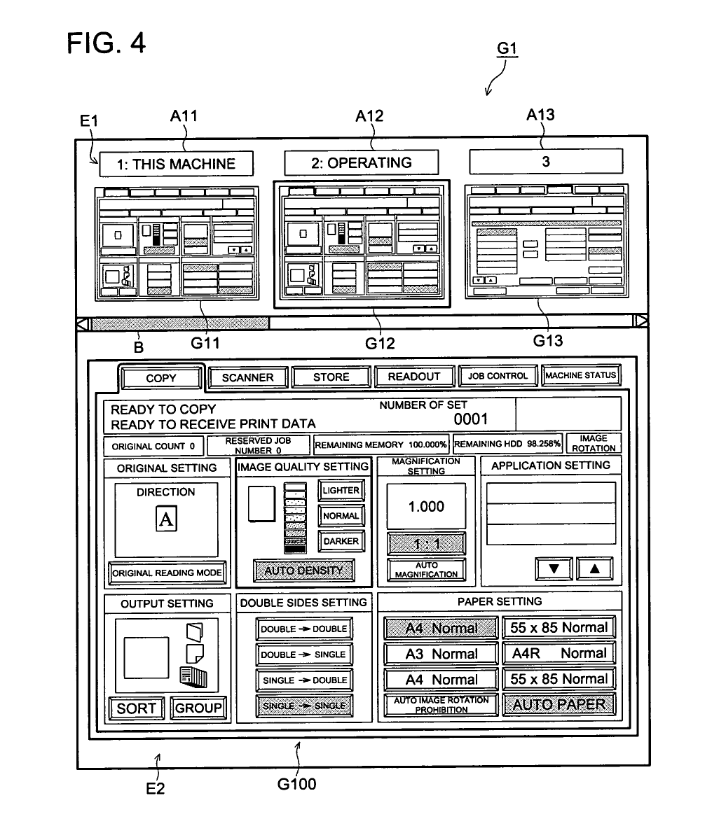

FIG. 4 shows an example of the display image G1 displayed in the display section 260 of the image forming apparatus 21.

The display screen G1 shown in FIG. 4 has an operation screen list display area E1 and a selected operation screen display area E2.

The operation screen list display area E1 displays a plurality of thumbnails G11, G12, G13 and so on that the operation screens of the own apparatus and other image forming apparatuses are reduced, and operation screen identification names A11, A12, A13 and so on that the names for identifying the image forming apparatuses corresponding to each of the thumbnails and the like are displayed. The operation screen list display area E1 includes a scrollbar B for allowing the thumbnails to be scrolled and displayed.

As described above, providing the scrollbar B allows the thumbnails (operation screens) of the own apparatus and other image forming apparatuses to be scrolled and displayed, which makes it possible to move the thumbnails to allow the thumbnail that can not be displayed on the same display area to be displayed.

When any of the thumbnails G11, G12, G13 and so on is selected by the user's operation instruction, the selected thumbnail is displayed so as to inform the user about the selection in such a manner that the frame around the selected thumbnail is displayed in a different color from the other thumbnails, blinking, or its brightness is increased or decreased compared to the other thumbnails. In the display screen G1 shown in FIG. 4, the example that the frame around the thumbnail G12 is displayed in a different color from the other thumbnails is shown.

The operation screen identification names A11, A12, A13 and so on indicate the names of the image forming apparatuses corresponding to each of the thumbnails. The operation screen identification name for the thumbnail selected by the user's operation instruction also indicates that it is the thumbnail of the selected operation screen displayed in the selected operation screen display area E2.

For example, in FIG. 4, the operation screen identification name A11 shows the message “this machine” indicating that the image forming apparatus corresponding to the thumbnail G11 is the own apparatus and the identification number “1”. The operation screen identification name A12 indicates that the image forming apparatus corresponding to the thumbnail G12 is the image forming apparatus of the identification number “2”, and that the thumbnail is selected by the user's operation instruction with the message “operating” indicating that the thumbnail is of the selected operation screen displayed in the selected operation screen display area E2. The operation screen identification name A13 indicates that the image forming apparatus corresponding to the thumbnail G13 is the image forming apparatus of the identification number “3”.

The selected operation screen display area E2 displays the selected thumbnail which is enlarged to the size of its original operation screen. Thus, the selected operation screen display area E2 can display the selected and instructed operation screen in a larger size than the other operation screens, allowing the user to easily grasp the functional information and operation status information that the selected and instructed operation screen shows.

The functional information is the information indicating the functions the image forming apparatus has, for example, including the image density information in image forming, the information on the type of recording medium on which the image is formed and other information. The operation status information is the information indicating the operation status of the image forming apparatus, for example, including whether the image forming is possible, it is warming up, toner replacement is required, and other conditions.

When the user presses a position on the touch panel 251 corresponding to each of the function items shown in the enlarged displayed thumbnail (selected operation screen G100), the operation section 250 detects the coordinates corresponding to the position of the function item, sends the detected coordinates to the controller 210 as the function item assignment information. The controller 210 executes the operation instruction of the image forming apparatus corresponding to the selected operation screen G100.

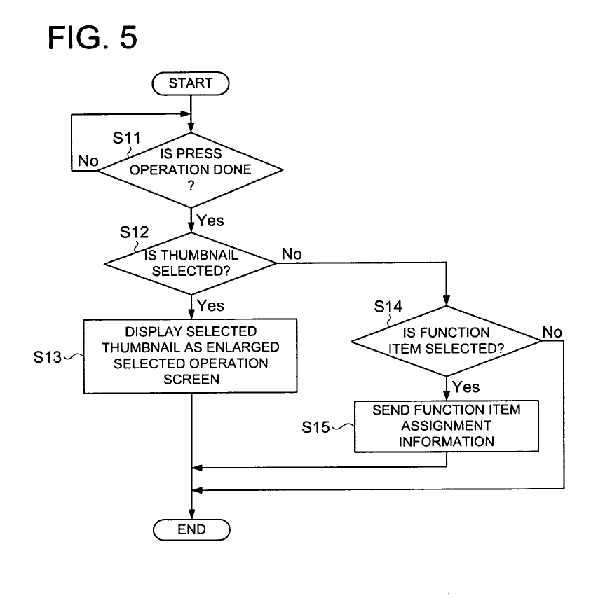

FIG. 5 shows the flow of the operation screen switching operation that is executed when the user makes the operation instruction to the display screen G1 shown in FIG. 4. Incidentally, assuming that the flow of the operation of operation screen switching operation shown in FIG. 5 is repeatedly executed periodically at a predetermined interval during the period of time in which the power is supplied to the image forming apparatus 21.

The controller 210 of the image forming apparatus 21 determines whether the touch panel 251 of the operation section 250 is pressed (Step S11), and when determining it is not pressed (Step S11: No), the controller 210 is standing by.

When determining that the touch panel of the operation section 250 is pressed (Step S11: Yes), the controller 210 of the image forming apparatus 21 receives the pressed coordinates and determines whether the received coordinates are the screen selection instruction signal for selecting and instructing one of the thumbnails G11, G12, G13 and so on of the operation screens of the own operation screen or other image forming apparatuses (Step S12).

When determining the received coordinates are the signal for selecting and indicating the thumbnail (namely, when any of the thumbnails G11, G12, G13 and so on is selected and instructed) (Step S12: Yes), the controller 210 of the image forming apparatus 21 allows the enlarged operation screen of the selected thumbnail to be displayed in the selected operation screen display area E2 as the selected operation screen (Step S13), and the operation of operation screen switch is ended.

When determining the received coordinates are not the signal for selecting and instructing the thumbnail (namely, when any of the thumbnails G11, G12, G13 and so on is not selected and instructed) (Step S12: No), the controller 210 of the image forming apparatus 21 determines whether the received coordinates are the signal for selecting and instructing the function item of the selected operation screen displayed in the selected operation screen display area E2 (Step S14).

The function item is the item indicating the function that the image forming apparatus has and the user can arbitrarily set, for example, including the item to allow the user to select the image density in image forming, the item to allow the user to select the type of recording medium on which the image is formed from a plurality of recording mediums.

When determining the received coordinates are the signal for selecting and instructing the function item (namely, when the function item of the selected operation screen is selected and instructed) (Step S14: Yes), the controller 210 of the image forming apparatus 21 sends the function item assignment information indicting the selected function item to the image forming apparatus corresponding to the selected operation screen (Step S15).

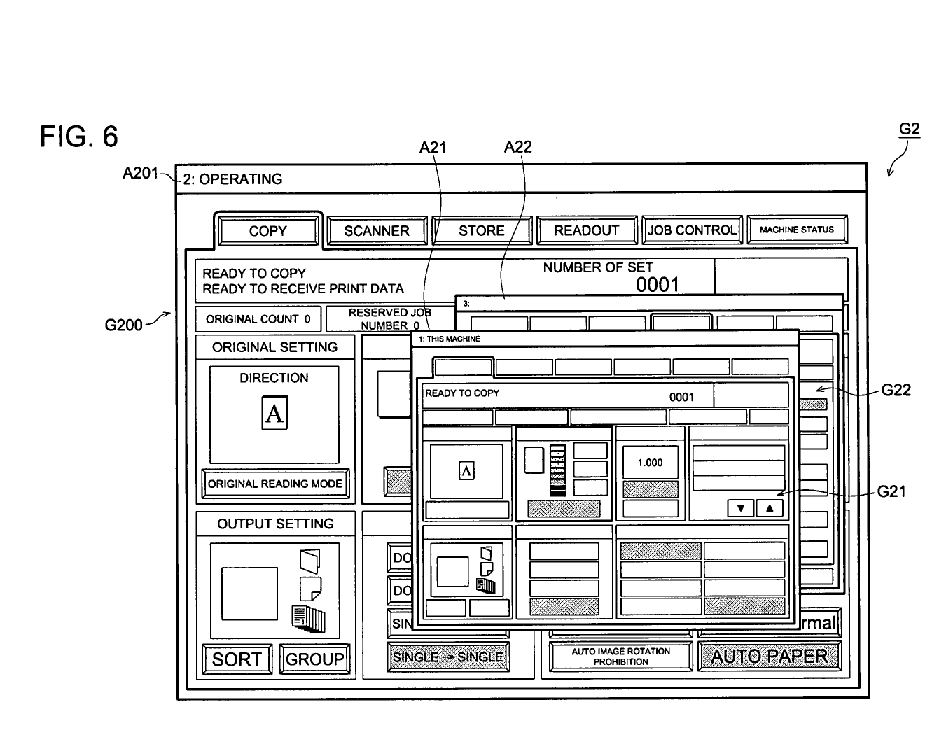

FIG. 6 shows another example of the display screen G2 that is displayed on the display section 260 of the image forming apparatus 21.

The display screen G2 shown in FIG. 6 displays the thumbnails G21, G22 that are overlapped on the enlarged selected operation screen G200.

As described above, the operation screen corresponding to the selected thumbnail and the thumbnails in which the operation screens of the non-selected own apparatus and other image forming apparatuses are reduced, are overlapped and displayed, so that the plurality of operation screens can be displayed at the same time in the limited range of the display area on the display screen.

The thumbnails G21, G22 are the thumbnails in which the operation screens of the own apparatus and other image forming apparatus are reduced, appended with the operation screen identification names A21, A22 that indicate the names of the image forming apparatuses corresponding to the thumbnails respectively.

In the enlarged selected operation screen G200 displays, based on the user's operation instruction, the selected thumbnail that is enlarged to the size of its original operation screen, appended with an operation screen identification name A201 that indicates the name of the image forming apparatus corresponding to the enlarged selected operation screen G200. The user can make the operation instruction of the image forming apparatus corresponding to the enlarged selected operation screen G200 by pressing the position corresponding to each of the function items shown in the enlarged selected operation screen G200.

For example, when the thumbnail G21 shown in FIG. 6 is selected based on the user's operation instruction, the thumbnail G21 is enlarged and displayed as the enlarged selected operation screen G200, while the operation screen having been displayed as the enlarged selected operation screen G200 is reduced and displayed on the enlarged selected operation screen G200 as the thumbnail. In other words, the operation screen shown as the thumbnail G21 and the operation screen shown as the enlarged selected operation screen G200 are replaced with each other.

Incidentally, the operation screen identification names A21, A22, A201 are substantially the same as the above described operation screen identification names A11, A12, A13 and so on, and the description is omitted.

Further, it is allowable that the operation screens corresponding to the image forming apparatuses are overlapped and displayed with each other and that the selected operation screen is displayed in the maximum screen size. However, the present invention is not limited to this, and any configuration may be used as long as the operation screen of the own apparatus or other image forming apparatus can be displayed on the display screen.

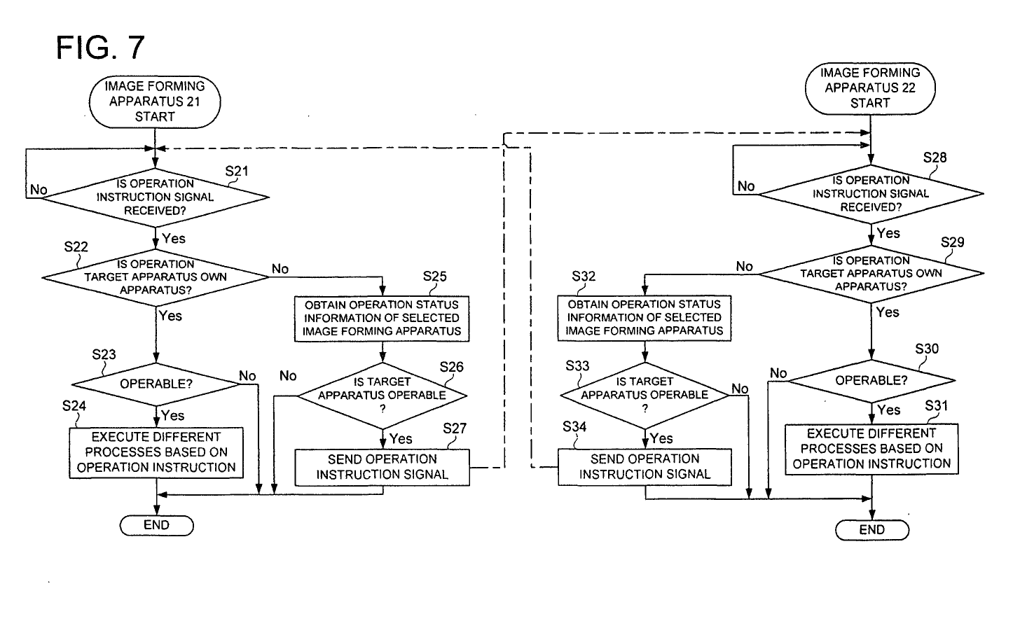

FIG. 7 shows the flowchart of the selection instruction operation that is executed when the user operates and instructs operation on the display screen of the image forming apparatus 21.

First, the controller 210 of the image forming apparatus 21 determines whether it has received the operation instruction signal indicating the operation instruction via the operation section 250 or the communication section 290 (Step S21), and when determining it has not received the operation instruction signal (Step S21: No), the controller 210 is standing by. Herein, the operation instruction signal includes the above described signal for selecting and indicating the thumbnail and the information of function item instruction.

When determining it has received the operation instruction signal via the operation section 2S0 or the communication section 290 (Step S21: Yes), the controller 210 of the image forming apparatus 21 determines whether the signal is the operation instruction for the own apparatus based on the received operation instruction signal (Step S22).

By providing the determination step of Step S22, the operation instruction for the other image forming apparatus is made executable regardless of the operation status of the own apparatus, when the selection indication is not for the own apparatus. This makes it possible to provide control (condition confirmation and operation) of the other image forming apparatus even if image forming is impossible in the own apparatus.

Herein, when receiving the signal for selecting and indicating the thumbnail, the controller 210 of the image forming apparatus 21 can determine whether the operation instruction is for the own apparatus based on whether the selected thumbnail is the thumbnail of the own apparatus. When receiving the function item assignment information, the controller 210 of the image forming apparatus 21 can determine it based on whether the selected operation screen is the operation screen for the thumbnail of the own apparatus.

When determining the operation instruction is for the own apparatus (Step 22: Yes), the controller 210 of the image forming apparatus 21 determines the operation status of the own apparatus, such as whether the own apparatus can execute the image forming operation (Step S23).

When determining the own apparatus is in inoperable condition (Step S23: No), the controller 210 of the image forming apparatus 21 ends without executing the process based on the operation instruction signal.

When determining the own apparatus is in operable condition (Step S23: Yes), the controller 210 of the image forming apparatus 21 executes different processes based on the operation instruction signal (Step S24), and then ends the operation.

When determining the operation instruction is not for the own apparatus (Step 22: No), the controller 210 of the image forming apparatus 21 obtains the operation status information of the selected image forming apparatus to be a target of the operation instruction (Step S25).

In order to obtain the operation status information of the selected image forming apparatus to be the target of operation instruction (for example, the image forming apparatus 22), the controller 210 of the image forming apparatus 21 sends an operation status request signal for requesting the operation status information of the image forming apparatus 22, and receives the operation status information of the image forming apparatus 22 from the image forming apparatus 22.

The controller 210 of the image forming apparatus 21 determines the operation status of the selected image forming apparatus to be the target of operation instruction based on the obtained operation status information (Step S26).

When determining the selected image forming apparatus to be the target of operation instruction is in inoperable condition (Step S26: No), the controller 210 of the image forming apparatus 21 ends the operation without sending the operation instruction signal to the selected image forming apparatus to be the target of operation instruction.

When determining the image forming apparatus to be the target of operation instruction is in operable condition (Step S26: Yes), the controller 210 of the image forming apparatus 21 sends an operation instruction signal to the selected image forming apparatus to be the target of operation instruction (Step S27), and then ends the operation.

The controller of the image forming apparatus 22 as the selected image forming apparatus to be the target of operation instruction determines whether it has received the operation instruction signal indicating the operation instruction via the operation section or the communication section (Step S28), and when determining it has not received the operation instruction signal (Step S28: No), the controller is standing by.

When determining it has received the operation instruction signal via the operation section or the communication section (Step S28: Yes), the controller of the image forming apparatus 22 determines whether the operation instruction is for the own apparatus based on the received operation instruction signal (Step S29).

Herein, the procedure for determining whether the operation instruction is for the own apparatus is the same as the above described Step S22, so that the description is omitted.

When determining the operation instruction is for the own apparatus (Step S29: Yes), the controller of the image forming apparatus 22 determines the operation status of the own apparatus, such as whether the own apparatus can execute the image forming operation (Step S30).

When determining the own apparatus is in the inoperable condition (Step S30: No), the controller of the image forming apparatus 22 ends the operation without executing the process based on the operation instruction signal.

When determining the own apparatus is in operable condition (Step S30: Yes), the controller of the image forming apparatus 22 executes different processes based on the operation instruction signal (Step S31), and then ends the operation.

When determining the operation instruction is not for the own apparatus (Step S29: No), the controller of the image forming apparatus 22 obtains the operation status information of the selected image forming apparatus to be the target of operation instruction (Step S32).

In order to obtain the operation status information of the selected image forming apparatus to be the target of operation instruction (for example, the image forming apparatus 21), the controller of the image forming apparatus 22 sends an operation status request signal for requesting the operation status information of the image forming apparatus 21, and receives the operation status information of the image forming apparatus 21 from the image forming apparatus 21.

The controller of the image forming apparatus 22 determines the operation status of the selected image forming apparatus to be the target of operation instruction based on the obtained operation status information (Step S33).

When determining the selected image forming apparatus to be the target of operation instruction is in inoperable condition (Step S33: No), the controller of the image forming apparatus 22 ends the operation without sending the operation instruction signal to the selected image forming apparatus to be the target of operation instruction.

When determining the image forming apparatus to be the target of operation instruction is in operable condition (Step S33: Yes), the controller of the image forming apparatus 22 sends an operation instruction signal to the selected image forming apparatus to be the target of operation instruction (Step S34).

Incidentally, when the controller ends the operation without executing the processes based on the operation instruction signal (after Steps 23, 30), or when the controller ends the operation without sending the operation instruction signal to the image forming apparatus to be the target of operation instruction (after Steps 26, 33), it is preferable to have a configuration to inform the user that the operation instruction is not executed, in such a manner that allows the information to be displayed on the display screen, or any sound signal to be output.

In the selection instruction control flow shown in FIG. 6, the description has been made in the case in which the user is working in the image forming apparatus 21 side while making the operation instruction for the image forming apparatus 22. Because the image forming apparatuses 21, 22, 23 each have the same function of executing the selection instruction control flow, for example, in the case in which the user is working in the image forming apparatus 22 side while making the operation instruction for the image forming apparatus 21 or the image forming apparatus 23, the same operation and advantage can be also obtained.

As described above, the operation screens of the other image forming apparatuses are displayed on the display screen of the display section on which the operation screen of the own apparatus is displayed, so that the user can operate the other image forming apparatus without moving to the other image forming apparatus or to the remote operation apparatus that is network-connected to monitor the entire network. By including the detailed condition such as the remaining paper and toner as the information to be included in the operation screen, the user can monitor the detailed condition of the other image forming apparatus, which makes it possible to provide an image forming system with improved usability for the user.

Further, when sending the function item assignment information, it is possible to confirm the operation status of the destination and prohibit the transmission of the information of function item instruction when the selected image forming apparatus is inoperable, so that the user can operate in accordance with the operation status of the selected image forming apparatus and can operate the image forming apparatus corresponding to the selected operation screen, without moving to the selected image forming apparatus or the remote operation apparatus that is network-connected to monitor the entire network, which makes it possible to improve the operability and usability for the user.

It is to be noted that the present invention is not limited to the contents of the above described embodiment, and can be modified accordingly without departing from the scope of the invention.

According to the above described embodiment, the display information of the other image forming apparatus is displayed on the display section of the own apparatus, so that the user can carry out control, for example, such as operation or condition monitoring of the other image forming apparatus without moving to the other image forming apparatus or the remote operation apparatus that is network-connected to monitor the entire network, which makes it possible to provide an image forming system or image forming apparatus with improved usability for the user.

Further, the display information of the other image forming apparatus is displayed together with the display information of the own apparatus, so that the user can control the own apparatus and the other image forming apparatus at the same time, which makes it possible to provide an image forming system or image forming apparatus with improved usability for the user.

Further, with the aspect to allow the operation screens of the own apparatus and other image forming apparatuses to be scrolled and displayed, when the plurality of operation screens can not be displayed side by side at the same time, it is possible to move the operation screens to display the operation screen which can not be displayed on the same display area.

With the aspect to allow the operation screens of the own apparatus and the other image forming apparatuses to be overlapped and displayed, it is possible to allow the plurality of operation screens to be displayed at the same time in the limited range of the display area of the operation screen.

With the aspect that the operation screen created based on the second display information displayed in the display section includes the substantially the same information as that of the operation screen displayed in the other image forming apparatus, the user can carry out control, for example, such as operation and condition monitoring of the other image forming apparatus without moving, which makes it possible to improve convenience for the user.

With the aspect that the display information includes the functional information or operation information of the image forming apparatus, the user can monitor the functional information or operation information that the own apparatus and the other image forming apparatuses displayed in the display section have.

With the aspect to display the selected and instructed operation screen in a larger size than the other operation screens, it is possible to allow the user to easily grasp the function items and operation status that the operation screen displayed in the display section shows.

With the aspect to send the function item assignment information to the image forming apparatus corresponding to the selected operation screen, the user can operate the image forming apparatus corresponding to the selected operation screen without moving to the other image forming apparatus or the remote operation apparatus that is network-connected to monitor the entire network, which makes it possible to improve usability for the user.

With the aspect to select the operation screen corresponding to the other image forming apparatus, select a plurality of function items the relevant operation screen has, and to send the function item assignment information to the other image forming apparatus corresponding to the selected operation screen, it is possible to improve operability and usability for the user even if the image forming operation is impossible in the own apparatus.

With the aspect that the transmission of the function item assignment information is prohibited when the selected image forming apparatus is inoperable, the user can operate in accordance with the operation status of the image forming apparatus of the destination, so that the operability can be further improved.

With the aspect that the transmission of the function item assignment information is prohibited when the image forming operation is not executable and/or the mutual communication operation is impossible, there is no need to carry out transmission control of unnecessary signals, so that the control load on the network can be reduced.

What is claimed is:

1. An image forming system including a plurality of image forming apparatuses which are connected to and capable of communicating with each other through a network, the image forming apparatus comprising:
a display section which displays first display information about image forming of the image forming apparatus;
a display control section which controls the display section to display second display information of another image forming apparatus connected to and capable of communicating with the image forming apparatus.

2. The image forming system of claim 1, wherein the display control section controls the display section to display the first display information together with the second display information.

3. The image forming system of claim 2, wherein the display control section controls the display section to display and scroll an operation screen which is produced based on the first display information and the second display information.

4. The image forming system of claim 2, wherein the display control section controls the display section to display the operation screens which are produced based on the first display information and the second display information in an overlapping display.

5. The image forming system of claim 3, wherein the operation screen produced based on the second display information includes substantially the same information as an operation screen displayed on the another image forming apparatus.

6. The image forming system of claim 1, wherein the display information includes at least one of functional information and operation status information of the image forming apparatus.

7. The image forming system of claim 1, the image forming apparatus comprising:
a selection input section for selecting an operation screen out of the operation screens which are produced based on the display information displayed on the display section and are displayed on the display section,
wherein the display control section controls the display section so that the display section displays the operation screen selected by the selection input section larger than the other operation screen.

8. The image forming system of claim 7, the selection input section comprising:
a plurality of function items which are the same as function items on the selected operation screen and able to be selected;
a selection assignment control section which sends a function item assignment information indicated by the function item selected by the selection input section to an image forming apparatus corresponding to the selected operation screen,
wherein the image forming apparatus corresponding to the selected operation screen includes a operation execution control section which makes the image forming apparatus execute an operation based on the function item assignment information.

9. The image forming system of claim 8, the image forming apparatus comprising:
an own apparatus operation status judgment section which judges whether the image forming apparatus is capable of executing an image forming operation or not,
wherein the image forming apparatus is configured to be capable of selecting an operation screen corresponding to another image forming apparatus, selecting a plurality of function items included in the operation screen and sending the function item assignment information to another image forming apparatus corresponding to the selected operation screen even when the own apparatus operation status judgment section determines the image forming operation not to be operable.

10. The image forming system of claim 8, wherein when the own apparatus operation status judgment section determines the image forming operation not to be operable, the image forming apparatus having the own apparatus operation status judgment section is prohibited from executing the image forming operation.

11. The image forming system of claim 8, wherein the selection assignment control section of the image forming apparatus sends an operation status request signal asking for operation status information of the image forming apparatus corresponding to the selected operation screen to the image forming apparatus corresponding to the selected operation screen and makes a judgment of an operation status of the image forming apparatus corresponding to the operation screen selected based on the operation status information received from the image information apparatus corresponding to the selected operation screen,
wherein the operation execution control section of the image forming apparatus corresponding to the selected operation screen sends the operation status information of the image forming apparatus corresponding to the selected operation screen to the image forming apparatus in case of receiving the operation status request signal.

12. The image forming system of claim 11, wherein the selection assignment control section of the image forming apparatus prohibits the sending of the function item assignment information in case that the image forming apparatus determines a result of the judgment of the operation status of the image forming apparatus corresponding to the selected operation screen to be inoperative.

13. The image forming apparatus of claim 11, wherein the judgment of the operation status is a judgment whether the image forming operation to be operable or not and/or a communication operation with each other to be operable or not.

14. The image forming system of claim 1, wherein in case of receiving the second display information from the another image forming apparatus, the display control section controls the display section to display the second display information.

15. An image forming apparatus, comprising:
a display section which displays first display information about image forming of the image forming apparatus;
a display control section which controls the display section to display second display information of another image forming apparatus connected to and capable of communicating with the image forming apparatus.

16. The image forming apparatus of claim 15, wherein the display control section controls the display section to display the first display information together with the second display information.

17. The image forming apparatus of claim 16, wherein the display control section controls the display section display and scroll an operation screen which is produced based on the first display information and the second display information.

18. The image forming apparatus of claim 16, wherein the display control section controls the display section to display the operation screens which are produced based on the first display information and the second display information in an overlapping display.

19. The image forming apparatus of claim 17, wherein the operation screen produced based on the second display information includes substantially the same information as an operation screen displayed on the another image forming apparatus.

20. The image forming apparatus of claim 15, wherein the display information includes at least one of functional information and operation status information of the image forming apparatus.

21. The image forming apparatus of claim 15, the image forming apparatus comprising:
a selection input section for selecting an operation screen out of the operation screens which are produced based on the display information displayed on the display section and are displayed on the display section,
wherein the display control section controls the display section so that the display section displays the operation screen selected by the selection input section larger than the other operation screen.

22. The image forming apparatus of claim 21, the selection input section comprising:
a plurality of function items which are the same as function items on the selected operation screen and able to be selected; and
a selection assignment control section which sends a function item assignment information indicated by the function item selected by the selection input section to an image forming apparatus corresponding to the selected operation screen.

23. The image forming apparatus of claim 22, the image forming apparatus comprising:
an own apparatus operation status judgment section which judges whether the image forming apparatus is capable of executing an image forming operation or not,
wherein the image forming apparatus is configured to be capable of selecting an operation screen corresponding to another image forming apparatus, selecting a plurality of function items included in the operation screen and sending the function item assignment information to another image forming apparatus corresponding to the selected operation screen even when the own apparatus operation status judgment section determines the image forming operation not to be operable.

24. The image forming apparatus of claim 23, wherein when the own apparatus operation status judgment section determines the image forming operation not to be operable, the image forming apparatus having the own apparatus operation status judgment section is prohibited from executing the image forming operation.

25. The image forming apparatus of claim 22, wherein the selection assignment control section of the image forming apparatus sends an operation status request signal asking for operation status information of the image forming apparatus corresponding to the selected operation screen to the image forming apparatus corresponding to the selected operation screen and makes a judgment of an operation status of the image forming apparatus corresponding to the operation screen selected based on the operation status information received from the image information apparatus corresponding to the selected operation screen.

26. The image forming apparatus of claim 25, wherein the selection assignment control section of the image forming apparatus prohibits the sending of the function item assignment information in case that the image forming apparatus determines a result of the judgment of the operation status of the image forming apparatus corresponding to the selected operation screen to be inoperative.

27. The image forming apparatus of claim 25, wherein the judgment of the operation status is a judgment whether the image forming operation to be operable or not and/or a communication operation with each other to be operable or not.

28. The image forming apparatus of claim 15, wherein in case of receiving the second display information from the another image forming apparatus, the display control section controls the display section to display the second display information.
